(19) United States
(12) Patent Application Publication
(10) Pub. No.: US 2005/0144316 A1
(43) Pub. Date: Jun. 30, 2005

(54) Method and system for service node redundancy

(76) Inventors: William Loo, Kirkland (CA); Maja Krleza-Lesko, Montreal (CA)

Correspondence Address: Alex Nicolaescu, 8400 Decarie Bld, QA3096, Montreal, QC, H4P 2N2, CA

(21) Appl. No.: 10/729,466

(22) Filed: Dec. 6, 2003

(51) Int. Cl. G06F 15/173

(52) U.S. Cl. 709/238

(57) ABSTRACT

A method and processing node for processing node redundancy, wherein an unavailability of a primary processing node is first detected, and the linkset route to the unavailable node is inhibited by sending Transfer Prohibited (TFP) messages to Signal Transfer Point (STPs) adjacent to the unavailable node. Further, Transfer Allowed (TFA) messages are sent to the STPs in order to enable an alternate linkset route to the secondary processing node, i.e. the standby backup node. A Virtual Service Address (VSA) is reassigned from the unavailable primary node to the remaining node that takes over the processing of the unavailable node and thus becomes the primary processing node. The unavailability of the processing node may be detected via a heartbeat mechanism between the two redundant nodes, or via receipt of TFP messages from the adjacent STPs. The method and processing node may be used in a hot standby configuration or in a load sharing configuration.

### BACKGROUND OF THE INVENTION

1. Field of the Invention

The present invention relates to a method and system for providing service redundancy.

2. Description of the Related Art

In many Signalling System #7 (SS7) network-based applications, there is a need for network redundant service nodes. Network redundancy means that when one node becomes unserviceable, its data processing is taken over by another node, with minimal or no loss of data during the switchover. Such cooperating nodes are said to be mutually redundant, so that each node can stand in for another in case of a failure. In order to be able to cope with local and regional disasters (such as fire or earthquake) that can disable multiple nodes at the same time, the cooperating nodes are typically set to be separated by a given geographical distance.

In a “hot-standby” configuration, it is possible to designate one of the two nodes for normal traffic handling, and to set the remaining node to serve as a passive hot standby node. If the primary node fails, the hot standby node instantly steps in to assume the load.

In a “load-sharing” configuration of network redundancy, there are two cooperating service nodes. During normal operation, each node receives traffic destined for it. In the event of a failure of one of the nodes, the remaining node will instantly step, take over the data traffic processing destined to the failed node, and thus handle the traffic for both nodes. As a result, the load on the surviving node is doubled.

In all types of node redundancy, one important criterion for effectiveness is that the failure of one of the two cooperating nodes is transparent to the external network.

In SS7, a mechanism exists and is designed to overcome network failures within the Signalling Connection Control Protocol (SCCP). SCCP allows several nodes that offer the same type of service (called a subsystem) to be defined. Traffic can be directed towards these nodes on a load-shared basis or, alternatively, a hot-standby configuration can be defined among these nodes. Management messages are exchanged between nodes in order to communicate the status of adjacent nodes, so that traffic can be shunted away from failed nodes. The SCCP redundancy scheme assumes that alternate nodes are equivalent in terms of their ability to provide a service (i.e., there is no difference between the information provided by each of the alternate nodes). This is of course not always the case. In many real systems, the master source of information is located at a unique node of the network. The SCCP redundancy provisions are suitable only for relatively static information (such as routing information) that does not undergo frequent changes. Secondly, SCCP operates on the basis of subsystems only, not directly on a given node. When SCCP messages are re-routed due to a failure, only the subsystems affected by the failure are re-routed, while other subsystems continue to use the old route. While this can be regarded as an increased routing flexibility, its usefulness is limited to intermediate nodes, or Signal Transfer Points (STP), that serve to route traffic for a much larger number of destination nodes (SS7 endpoints). For these endpoint nodes, it is necessary to re-route all subsystems hosted by a particular node that has failed. Finally, the SCCP redundancy scheme is usable only if the SCCP protocol is used. This is a critical limitation, as the basic message packet in SS7 is the Message Signal Unit (MSU), an entity of the lower-layer Message Transfer Part (MTP) protocol.

Aside from the SCCP redundancy scheme, there is no known implementation of a network redundancy solution using cooperating and mutually redundant nodes that can be deployed in a general SS7 network. The main difficulty of such a solution is to overcome the fixed point code addresses of each one of the processing nodes. If peer nodes in the SS7 network are notified of a failure in the primary processing node, then it would be possible for the peer nodes to switch their traffic to the alternate processing node. However, by doing so, the nodal failure is no longer transparent to the external network, thus reducing the effectiveness of the redundancy solution. This sub-optimal state of the art can be virtually viewed as a processing node telling each of its peers or clients: “Use this address A to reach me. When it does not work anymore (because of network failures or computer failures at my end), try this 2^{nd} address B. Continue using B until I tell you to switch back to A.” This approach contrasts with an actual network-transparent redundancy scheme wherein a processing node can be virtually viewed as saying: “Use this address A to reach me. It will always work, regardless of network failures or computer failures at my end.”

Although there is no prior art solution as the one proposed hereinafter for solving the above-mentioned deficiencies, the U.S. Pat. No. 6,108,300 issued to Coile et al (hereinafter called Coile) bears some relation with the field of the present invention. Coile teaches a system and method for transferring a network function from a primary network device to a backup network device. The backup network device first detects that the primary network device has failed and informs the primary network device. The IP address of the backup network device changes from a standby IP address to an active IP address, and the IP address of the primary network device changes from the active IP address to the standby IP address. Packets sent to the active IP address are then handle with the backup network device.

Coile fails tot teach a redundancy scheme optimized for SS7 processing nodes.

Accordingly, it should be readily appreciated that in order to overcome the deficiencies and shortcomings of the existing solutions, it would be advantageous to have a method and system for effectively providing transparent redundancy services in an SS7 based networks of processing nodes. The present invention provides such a method and system.

### SUMMARY OF THE INVENTION

A method and processing node for processing node redundancy, wherein an unavailability of a primary processing node is first detected, and the linkset route to the unavailable node is inhibited by sending Transfer Prohibited (TFP) messages to Signal Transfer Point (STPs) adjacent to the unavailable node. Further, Transfer Allowed (TFA) messages are sent to the STPs in order to enable an alternate linkset route to the secondary processing node, i.e. the standby backup node. A Virtual Service Address (VSA) is reassigned from the unavailable primary node to the remaining node that takes over the processing of the unavailable node and thus becomes the primary processing node. The unavailability of the processing node may be detected via a heartbeat mechanism between the two redundant nodes, or via receipt of TFP messages from the adjacent STPs. The method and processing node may be used in a hot standby configuration or in a load sharing configuration.

In one aspect, the present invention is a Signalling System #7 (SS7) processing node comprising:
a Signal Transfer Element for routing incoming and outgoing messages;
a Signal Processing Element (STE) for processing the messages, the STE being assigned a non-permanent Virtual Service Address (VSA);
wherein when the processing node detects an unavailability of a cooperating processing node, the processing node issues a Transfer Allowed (TFA) message to an adjacent Service Transfer Point (STP) for enabling a linkset route between the STP and the processing node.

In another aspect, the present invention is a method for processing node redundancy comprising the steps of:
detecting by a first processing node an unavailability of a second processing node, wherein the first and second processing nodes are redundant processing nodes;
sending from the first processing node to an adjacent Service Transfer Point (STP) a Transfer Allowed (TFA) message for enabling a linkset route between the STP and the processing node.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary high-level network diagram illustrative of the first preferred embodiment of the present invention;

FIG. 2 is an exemplary high-level network diagram illustrative of the second preferred embodiment of the present invention; and

FIG. 3 is an exemplary high-level network diagram illustrative of the third preferred embodiment of the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

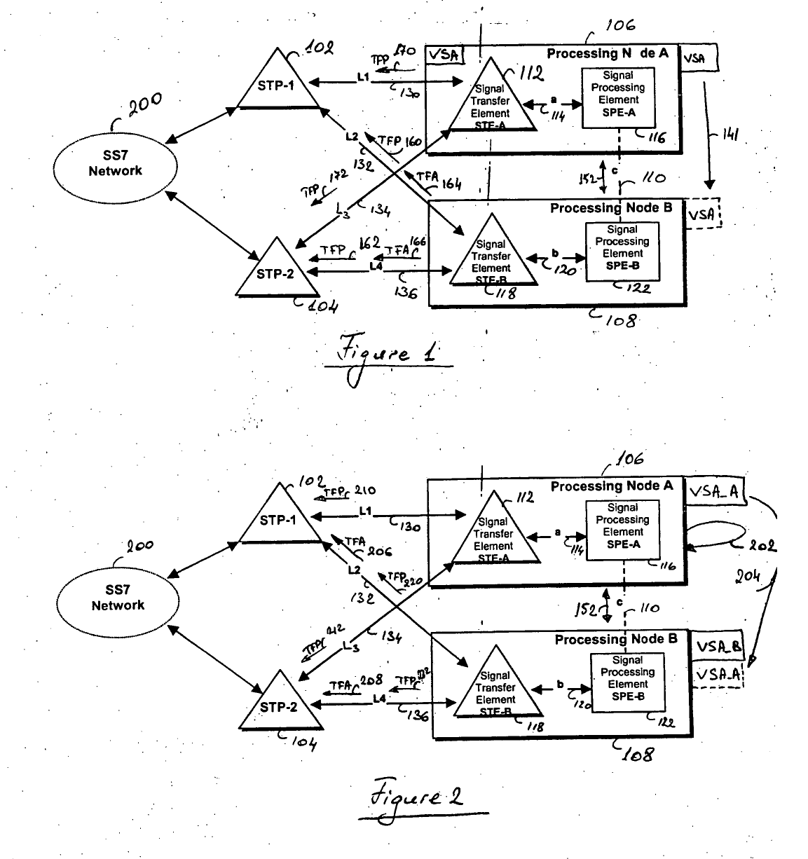

Reference is now made to FIG. 1, which is an exemplary high-level network diagram illustrative of a network implementing a first preferred embodiment of the present invention. Shown in FIG. 1 is first a Signalling System #7 (SS7) network 200 that connects to two Signal Transfer Points (STPs) STP-1 102 and STP-2 104, which serve as redundant signalling gateways for the end point service processing nodes A and B. The processing nodes A 106 and B 108 may be geographically separated, and may be connected via an inter-node link c 110, which serves as a conduit for exchanging node status information regarding each one of the nodes 106 and 108, and for data exchanges, such as replication of data of one node onto the other node when processing nodes A and B operate as redundant nodes. Processing node A 106 comprises a routing element Signal Transfer Element STE-A 112, connected via an internal link a 114 to a processing element Signal Processing Element SPE-A 116. Similarly, processing node B 108 comprises a routing element STE-B 118 connected via internal link b 120 to processing element SPE-B 122. The STP-1 102 and STP-2 106 are connected to the routing elements STE-A 112 and STE-B118 respectively via linksets L1-L4, noted 130-136 as shown. Therefore, from the point of view of STP-1 and STP-2, STE-A and STE-B appear as adjacent STPs.

The processing nodes A 106 and B 108 are cooperating redundant nodes. Each one is ready to fill-in for the other's processing task as soon as the other node experiences a failure. Also, any update signalling transaction performed on data of one node needs to be replicated to the standby copy of the data in the remote node. This active mirroring of the processing performed on the primary node (master) is replicated onto the secondary node (the salve) and is necessary in order to realize a ‘hot’ standby capability. For this purpose, continuous exchanges of data and control information take place between the two redundant nodes. The link c 110 between the 2 nodes is the data channel that allows for the data and control information mirroring taking place between the two processing nodes 106 and 108.

Hot Standby Redundancy

According to the first preferred embodiment of the present invention, herein designated as a hot standby redundancy, one of the two processing nodes A 106 and B 108 is designated as the primary node, while the other node is the designated as a secondary, standby node. In the present exemplary scenario, processing node A 106 is considered to be the primary processing node, i.e. the processing node that receives and processes data signalling originated from the SS7 network 200, while the processing node B 108 is assigned the role of the secondary processing node, i.e. the processing node that is in hot-standby with respect to the primary node, and that takes over the processing of the primary node when that node fails. It is understood that in order to be able to perform this task, the data processed by the primary node A 106 is continuously replicated or copied from the primary node A 106 to the secondary processing node B 108, such as for example via the link c 110.

In order to overcome the limitation imposed by the requirement that nodes A and B have distinct addresses, and yet to have a unique service address to which data signalling traffic can be directed to (without knowing which of nodes A or B is the current primary node), the present invention introduces a concept of the 3^{rd} point code address, distinct from the addresses already assigned to the processing nodes A and B, to serve as a service address. This 3^{rd} address is herein designated as the Virtual Service Address (VSA), since it is not a fixed address that is permanently associated with either one of the processing nodes A or B. Rather, the VSA is assigned either to the SPE-A 116 or to the SPE-B 122, depending on which one is designated as the processing element of the primary node at one given moment. That is, if the processing node A 106 is the primary node, then the VSA is assigned to the SPE-A 116. Similarly, if the processing node B is the primary node, the VSA is assigned to the SPE-B 122. Both STE-A 112 and STE-B 118 are viewed as gateway STPs by the SPE that is assigned the VSA.

STP-1 102 considers that either linkset L1 130 or linkset L2 132 can be used to transfer signalling messages destined for the processing node having assigned the VSA, through the gateway STPs STE-A 112 and STE-B 118 respectively.

Similarly, STP-2 104 considers that either linksets L3 134 or L4 136 can be used as possible routes to reach the processing node currently having assigned the VSA. Therefore, when the processing node A 106 is designated as primary, STP-1 102 chooses the linkset L1 130 for transiting signalling messages destined for the VSA, while STP-2 104 uses linkset L3 134. Similarly, when the processing node B 108 becomes primary, STP-1 chooses the linkset L2 132 when transiting messages destined for the VSA, while STP-2 104 uses linkset L4 136.

In order to be bale to manage the signalling linkset used by STPs STP-1 102 and STP-2 104, the invention uses a traffic route management mechanism that makes use of inter-STP messages sent to advise neighbouring STPs of the availability or unavailability of a route for transiting messages to a specific destination. Transfer Prohibited (TFP) and Transfer Allowed (TFA) route management messages are used for this purpose. The TFP and TFA messages typically comprise three (3) components: the identity of the sending STP node, the identity of the receiving STP node, and the identity of the concerned node (for which transfer should be prohibited or allowed).

A TFP message sent by an STP p concerning an endpoint w, to an adjacent STP q, instructs q that it must stop transiting SS7 signalling messages, destined for w, through p (because the route from p to w is unserviceable).

A TFA message sent by a STP p concerning an endpoint w, to an adjacent STP q, instructs q that it may resume transiting SS7 messages, destined for w, through p (because the route from p to w is once again serviceable).

The present invention allows for the use of TFP and TFA messages in order to re-direct signalling traffic to the node that is currently serving as the primary processing node, while maintaining the use of a single service address, i.e. the VSA, that does not change. In this manner, as soon as the failure of the primary processing node is detected by the secondary processing node, the secondary processing node makes use of the TFA and TFP messaging in order to instruct the cooperating STPs to re-direct the traffic to the secondary processing node, that at that moment becomes the primary processing node with the assignment of the VSA.

The functioning of the network shown in the FIG. 1 will now be concomitantly described with the method for operating such a network.

Initially, the processing node A 106 is designated as the primary node and the processing node B 108 is designated as the secondary processing node in hot standby mode. In action 150, it is assumed that at a given point in time it is desired to remove the processing node A 106 from traffic, or that a signalling and/or processing error occurred for node A, such as for example an internal malfunction, a node shutdown, or a disruption of one or more of the linksets L1 130 and L2 132. In action 152, the processing node B 108 detects the unavailability related to node A 106, via a heartbeat mechanism that may be performed, for example, every second. When the processing node B 108 detects the failure, the VSA is moved from being assigned to the SPE-A 116 of the failed node A 106 to the SPE-B 122 of the remaining node B 108, action 141. Further, the STE-B 118 sends TFP messages 160 and 162 to STP-1 102 and STP-2 104 respectively for prohibiting traffic destined for the VSA to flow towards STE-A 112. Responsive to receipt of messages 160 and 162, the STP-1 102 and STP-2 104 stop sending signalling traffic along routes L1 130 and L3 134 to the unavailable node A 106.

At substantially the same time, STE-B 118 broadcasts to STP-1 102 and STP-2 104 TFA messages 164 and 166 respectively, allowing the transfer of signalling messages destined for the VSA through STE-B 118. Responsive to the TFA messages 164 and 166, the STP-1 102 and the STP-2 104 enable the linksets L2 132 and L4 136 toward the processing node B 108 that becomes the primary processing node. This combination of TFP and TFA messages has the effect of switching traffic for the VSA away from the failed node's STE-A 112 and re-directing it towards STE-B 118.

The switching of the primary node function between A and B can be undertaken at any time, as often as necessary. For example, in a variant of this first preferred embodiment of the invention, it is rather the primary processing node A 106 that may detect its own, partial, internal malfunction, or alternatively may detect a malfunction on any one or more of its linksets L1 130 or L3 134, and responsive to this detection to issue its own TFP messages 170 and 172 instructing the STP-1 102 and the STP-2 104 to stop sending signalling traffic to it. If the processing node A 106 has completely failed, then of course STE-A 112 is no longer in a position to send a TFP messages. In such a case, STP-1 102 and STP-2 104 may autonomously detect that messages can no longer transit through STE-A 112, and seek another route. Such a route has been opened by the TFA messages 164 and 166 issued by STE-B 118. According to this variant of the first preferred embodiment of the invention, the TFA messages 164 and 166 may be sent as previously described by the processing node B 108 that takes over the signalling processing.

Load Sharing Redundancy

According to the second preferred embodiment of the present invention, herein designated as the load sharing redundancy, both processing nodes A 106 and B 108 have equal status, wherein each node normally processes its share of the signalling traffic load. Typically, this split of the traffic load is based on the service address of the processing nodes, i.e. each one of the nodes has its own service address, to which signalling messages are directed from the SS7 network. When one of the nodes fails, the other node takes over the processing of the failed node, on top of its own processing. This redundancy scheme is symmetrical, as each node can take over for the other.

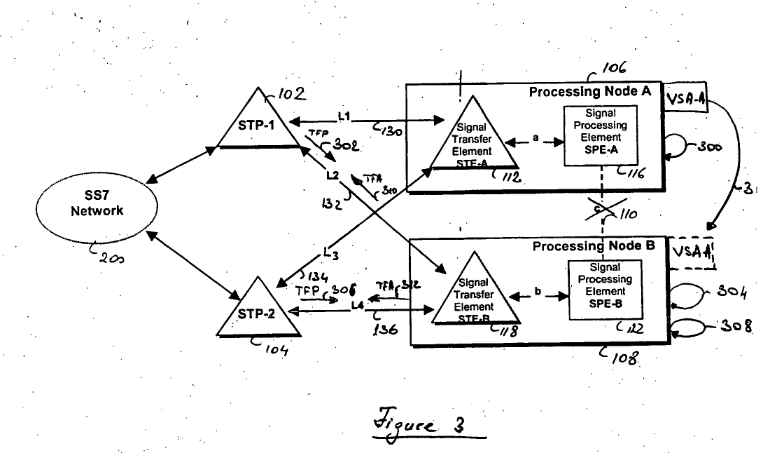

Reference is now made to FIG. 2, which is a high-level network diagram illustrative of the second preferred embodiment of the invention. FIG. 2 shows elements similar to the ones previously described with reference to FIG. 1, except for the fact that the processing nodes A 106 and B 108 works in a load sharing redundancy scheme, wherein during normal operation each node processes its own share of the signalling traffic by being assigned its own VSA. Thus, the processing node A 106 is assigned VSA-A, while the processing node A 106 is assigned VSA-B. Each node is also the standby node (backup) of the other node, such that VSA-A is primary VSA in node A 106 and standby in node B 108. Conversely, VSA-B is primary in node B 108 and standby in node A 106. It is assumed that processing node A 106 is the primary node for service address VSA-A while the processing node B 108 is the primary node for service address VSA-B.

The functioning of the system shown in FIG. 2 will now be described concomitantly with the method of operating such system. Each one of STE-A 112 and STE-B 118 is regarded by STP-1 102 and STP-2 104 as gateway routers to reach both addresses VSA-A and VSA-B. If no control is put into place, STP-1 102 uses linksets L1 130 and L2 132 to transit signalling messages destined to VSA-A and VSA-B respectively. Likewise STP-2 104 uses linksets L3 134 and L4 136 to transit signalling messages destined to VSA-A and VSA-B respectively.

As long as at least one of linksets L1 130 and L3 132 remains serviceable, signalling traffic for VSA-A continues to flow towards STE-A 112 from one of STP-1 102 and STP-2 104. Even when only one of the two linksets is serviceable, the system can continue in its present configuration with reduced capacity and failure resistance, until for example a decision is be made to change the primary node for the service address.

In the present exemplary scenario, it is assumed that at a given point in time it is desired to remove the processing node A 106 from traffic, or that signalling and/or processing capability of that node has failed, action 202. The failure of the processing node A 106 may be detected by the cooperating node B 108 via a heartbeat exchange mechanism, action 152. This triggers the reassignment of the service address VSA-A that was primary in the no longer available node A 106, to the surviving node B 108 so that signalling traffic intended for the processing node A 106 can be re-directed to the standby (backup) node B 108, action 204. In order to also allow the signalling traffic destined for VSA-A to reach the backup node B 108, the STE-B 108 broadcasts to STP-1 102 and STP-2 104 TFA messages 206 and 208, enabling the transfer of signalling messages destined for VSA-A to STE-B 118 via linksets L2 132 and L4 136. At the same time, STE-A 112 sends TFP messages 210 and 212 to STP-1 102 and STP-2 104, prohibiting VSA-A bound traffic to reach STE-A 112. This combination of TFP and TFA messages has the effect of switching traffic destined for VSA-A away from STE-A 112 and directing it instead towards through STE-B 118.

Alternatively, instead of TFP messages 210 and 212 being sent by node A 106, TFP messages 220 and 222 may be sent to the STP-1 102 and STP-2 104 respectively by the processing node B 108, following the detection of the unavailability of the processing node A 106 in action 152.

The switching of the primary node function for VSA-A and VSA-B between A and B can be undertaken at any time, as often as necessary.

Failure Detection by Cooperating Node

According to the third preferred embodiment of the present invention, there is provided a method and system that allow each one of the redundant processing nodes to deduce the ability of the other node to process traffic even in instances wherein the link c 100 has failed, and when the inter-node heartbeat mechanism 152, previously described, is disrupted. This permits the remaining node to detect the moment when the traffic processing capability of the remote node has stopped, so that TFA messages can still be issued to the STPs in order to re-route traffic to the remaining node, and thus to prevent a total traffic outage.

Reference is now made to FIG. 3, which describes the same network as in FIGS. 1 and 2, except for the fact that the inter-node link c 110 is down, malfunctioning or inexistent. It is also assumed that the primary processing node A is assigned the VSA-A and that the processing node B acts as a stand-by node with respect to node A.

In the present exemplary scenario, it is assumed that STP-1 102 and STP-2 104 can no longer route traffic through STE-A 112, because STE-A 112 has failed, or the entire processing node A 106 has failed. STP-1 102 and STP-2 104 therefore has no available routes to communicate with the service address VSA-A of the processing node A 106.

Once the processing node A becomes unavailable, action 300, STP-1 102 and STP-2 104 issue TFP messages to all their neighbouring STPs, advising them that no messages destined for the service address VSA-A can be transited through them. Included in the set of adjacent STPs being so advised is also STE-B 118, since STE-B 118 acts like a gateway STP to the service address VSA-A. Therefore, STE-B 118, and hence the processing node B 108 is notified via the TFP message 302 that signalling processing has failed in node A 106. If such a TFP is received only from one STP and not the other (not also from the STP-2 104), the processing node B 108 deduces that only one STP, i.e. the STP-1 that originated the TFP message 302, has lost its routing capacity toward the service address VSA-A, action 304. Alternatively, when TFP messages 302 and 306 are received from both STP-1 102 and STP-2 104 respectively, because not only STP-1 102 but also STP-2 104 has lost contact with processing node A 106, the node B 108 deduces that signalling processing has completely failed in the node A 106, action 308.

When the processing node B 108 detects the failure of node A 106, it issues TFA messages 310 and 312 towards STP-1 102 and STP-2 104 respectively, in order to open/activate the linksets L2 132 and L4 136 to the VSA-A, that is transferred to the processing node B, action 314. In response, STP-1 102 and STP-2 104 start to use linksets L2 132 and L4 136 to transit traffic signalling messages for the VSA-A.

Therefore, with the present invention it becomes possible to rapidly enable alternative routes for transiting signalling messages toward a stand-by node in cases when the primary processing node has failed or is otherwise unreachable.

Based upon the foregoing, it should now be apparent to those of ordinary skills in the art that the present invention provides an advantageous solution, which offers en efficient solution for processing nodes redundancy. It should be realized upon reference hereto that the innovative teachings contained herein are not necessarily limited thereto and may be implemented advantageously with various radio telecommunications standards. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A Signalling System #7 (SS7) processing node comprising:
a Signal Transfer Element for routing incoming and outgoing messages;
a Signal Processing Element (STE) for processing the messages, the STE being assigned a non-permanent Virtual Service Address (VSA);
wherein when the processing node detects an unavailability of a cooperating processing node, the processing node issues a Transfer Allowed (TFA) message to an adjacent Service Transfer Point (STP) for enabling a linkset route between the STP and the processing node.

2. A method for processing node redundancy comprising the steps of:
detecting by a first processing node an unavailability of a second processing node, wherein the first and second processing nodes are redundant processing nodes;
sending from the first processing node to an adjacent Service Transfer Point (STP) a Transfer Allowed (TFA) message for enabling a linkset route between the STP and the processing node.
